(19) United States
(12) Patent Application Publication
(10) Pub. No.: US 2025/0327359 A1
(43) Pub. Date: Oct. 23, 2025

(54) GAP-ADJUSTABLE, QUICK NON-PENETRATING INSTALLATION ROLLER BLIND

(71) Applicant: HANGZHOU GIPUTA CLOTHING CO., LTD., Hangzhou (CN)

(72) Inventors: Yu PAN, Hangzhou (CN); Michael Alexander Mayer, Hangzhou (CN)

(73) Assignee: HANGZHOU GIPUTA CLOTHING CO., LTD., Hangzhou (CN)

(21) Appl. No.: 18/961,986

(22) Filed: Nov. 27, 2024

(30) Foreign Application Priority Data
Apr. 23, 2024 (CN) 2024208353250

(51) Int. Cl. E06B 9/42; E06B 9/60; E06B 9/78; E06B 9/80; E06B 9/84

(52) U.S. Cl. CPC E06B 9/42; E06B 9/60; E06B 9/78; E06B 9/84; E06B 2009/801

(57) ABSTRACT

The invention provides a gap-adjustable, quick non-penetrating installation roller blind, comprising a roller blind mechanism and a fixing mechanism. The fixing mechanism is supported between supporting walls and includes a non-penetrating installation mechanism and a supporting rail. A groove is provided at the lower end of the supporting rail. The roller blind mechanism is installed below the supporting rail, with a slider provided at the upper end of the roller blind mechanism. The roller blind mechanism achieves sliding relative to the supporting rail through the cooperation between the slider and the groove, and the slider and the groove prevent free sliding through interference fit or spring piece design. The invention allows the relative adjustment of the position of the curtain fabric after installation, ensuring even gaps on both sides and stable positioning of the curtain fabric by avoiding free sliding of the slider and the groove.

### FILED OF THE INVENTION

The invention relates to a roller blind, and more particularly to a gap-adjustable, quick non-penetrating installation roller blind.

### BACKGROUND OF THE INVENTION

Roller blinds typically come with manipulation mechanisms for raising and lowering the curtains. These control mechanisms can be divided into manual and electric types, with manual mechanisms being more common. Due to their location on one side of the roller blind and the potential for installation errors, the fabric often does not align perfectly with the window, resulting in uneven gaps on the left and right sides, affecting both light-blocking effectiveness and aesthetics. Additionally, roller blinds are commonly installed either by punching holes or through non-penetrating methods. Non-penetrating installations are increasingly popular due to their convenience and lack of damage to walls. With non-penetrating installation mechanisms mounted on curtain tracks, curtains and similar products can be installed on window frames, door frames, and other locations. Many non-penetrating curtain products on the market use threaded structures, but these threads can wear out after repeated use, making it difficult for users to tighten them by hand, requiring time and effort, and in some cases, even necessitating the use of a wrench for secure installation. Furthermore, measurement errors in window frame dimensions during non-penetrating installation can further contribute to uneven gaps between the fabric and the window frame. Therefore, it is essential to design roller blind products that are gap-adjustable and feature convenient non-penetrating installation methods.

### SUMMARY OF THE INVENTION

In response to the shortcomings of prior art, the objective of this invention is to provide a gap-adjustable, quick non-penetrating installation roller blind. Through the design of sliders and grooves, this roller blind allows for lateral adjustment of the curtain fabric during use. This feature addresses the issue of uneven gaps on the left and right sides of the roller blind, thereby enhancing both its light-blocking effectiveness and aesthetic appeal.

In order to achieve the above-mentioned object, the invention provided a gap-adjustable, quick non-penetrating installation roller blind, wherein:
Comprising a roller blind mechanism and a fixing mechanism, and the fixing mechanism is supported between supporting walls on both sides of the window, and the lower end of the roller blind mechanism is slidably connected to the fixing mechanism;
The fixing mechanism includes a non-penetrating installation mechanism, a supporting rail, and an end cap assembly. The non-penetrating installation mechanism and the end cap assembly are located on both sides of the supporting rail. The non-penetrating installation mechanism is used to enable the supporting rail to be fixed without drilling holes, and a groove is provided at the lower end of the supporting rail;
The roller blind mechanism is installed below the supporting rail, with a slider at the upper end, achieving lateral sliding relative to the supporting rail through the cooperation between the slider and the groove. The slider and the groove avoid free sliding through either of the following two methods:
The slider engages with the groove through an interference fit;
The upper surface of the slider is equipped with spring pieces, which come into contact with the sliding surface of the groove and exert pressure on the groove through their own elastic force.

Further, The roller blind mechanism comprises a roller blind installation mechanism and a roller blind body, and the roller blind installation mechanism mounts the roller blind body below the supporting rail;

The roller blind installation mechanism comprises a roller tube, a first mounting bracket, and a second mounting bracket. The upper end of the roller blind body is fixed to the roller tube, and the roller tube rotates in cooperation with the first and second mounting brackets, each of which has a slider that engages with the groove on the supporting rail, enabling lateral sliding of the roller blind mechanism relative to the supporting rail.

Further, the first and second mounting brackets have identical inverted L-shaped structures. The horizontal right angle edges of the first and second mounting brackets form sliders, while their vertical right angle edges rotate in cooperation with the ends of the roller tube.

Further, the roller blind mechanism further comprises a roller blind lifting mechanism for controlling the raising and lowering of the roller blind body;

The roller blind lifting mechanism includes a control rope, a fixing shaft, and a pulley assembly. The pulley assembly is mounted on the fixing shaft and fixedly installed at one end of the roller tube;

The control rope winds around the pulley assembly, and under external force, the control rope rotates the pulley assembly relative to the fixing shaft, which in turn rotates the roller tube, thereby raising or lowering the roller blind body.

Further, the roller blind lifting mechanism further comprises a locking mechanism in the roller blind lifting mechanism, including several torsion springs sleeved on the fixing shaft. The pulley assembly comprises a pulley and a pulley seat. The pulley includes a rope winding pulley and a pulley cylinder. The pulley cylinder is rotatably mounted on the outer periphery of the fixing shaft, and the pulley seat is then sleeved on the outer periphery of the pulley;

The pulley cylinder is provided with groove holes, which cooperate with the torsion springs so that when the pulley rotates, the torsion springs relax, causing the pulley to rotate relative to the fixing shaft. Corresponding positions inside the pulley seat are provided with convex platforms, which cooperate with the torsion springs so that when the rotating seat rotates, the locking component tightens, thereby stopping the rotation of the rotating seat.

Further, the roller blind mechanism further comprising a roller blind lifting mechanism for controlling the raising and lowering of the roller blind body;

The roller blind lifting mechanism includes a No-pull spring system and a locking head, both installed at the ends of the roller tube. The No-pull spring system rotates the roller tube under spring torque, while the locking head controls the locking and unlocking of the roller tube.

The locking head comprises a locking sleeve, a locking fixing shaft, and a track ball. The locking sleeve is rotatably sleeved on the locking fixing shaft, fixedly installed at one end of the roller tube, and the locking fixing shaft is fixedly installed on the first mounting bracket or the second mounting bracket set at the end of the roller tube;

The outer surface of the locking fixing shaft is provided with a track groove, and the corresponding position of the inner wall of the locking sleeve has a groove hole. The track ball is located inside the groove hole. When the locking sleeve rotates relative to the locking fixing shaft, the track ball moves along the track groove under the drive of the locking sleeve. At a certain position in the track groove, the track ball is unidirectionally locked.

Further, the No-pull spring system comprises a fixed rod, springs, a head, a damper, and a unidirectionally roller;

Both the head and the unidirectionally roller are both installed on the roller tube and rotate synchronously. One end of the fixed rod extends through the head and is fixedly mounted to the first or second mounting bracket, while the other end is fixedly mounted with the damper. The damper is assembled with the one-way roller, and a spring is mounted on the fixed rod, with its ends fixed respectively to the head and the housing of the damper;

When the roller tube rotates downward along the roller blind body, the head rotates together with the roller tube, causing the torsional force of the spring to increase. During this process, the damper moves under the action of the unidirectionally roller to provide damping. When the roller tube rotates upward along the roller blind body, the torsional force of the spring is released, causing the roller tube to rotate back. During this process, the unidirectionally roller rotates freely with the roller tube, and the damper remains stationary.

Further, the unidirectionally roller comprises a pulley body, a rotating shaft, and a rotating disk;

The pulley body is installed inside the roller tube and moves synchronously with it. The rotating disk is mounted inside the pulley body and rotatably sleeved on the shaft, the bottom of the pulley body is equipped with an inclined plane, which is used to match with the rotating disk;

One end of the rotating shaft is connected to the damper, and the rotating shaft is equipped with a gear disk, which is uniformly distributed with inclined teeth. These sawteeth can mesh with the inclined sawteeth on the rotating disk in same direction and disengage in the opposite direction, thereby achieving unidirectional rotation;

When the pulley body rotates downward along the roller blind body, the rotating disk and the rotating shaft fit together under the action of the inclined plane, and their sloping sawteeth mesh, thus achieving synchronized rotation; when the pulley body rotates in the opposite direction, the rotating disk disengages from the rotating shaft, and the rotating shaft remains stationary.

Further, the non-penetrating installation mechanism comprises a pre-tensioning component, a supporting component, a pressure component, and a button component;

The supporting components comprise a first supporting portion and a second supporting portion capable of relative sliding. The first supporting portion is supported on the supporting wall, while the second supporting portion is connected to the supporting rail. The pressure components consist of a first pressure portion and a second pressure portion. The first pressure portion is installed in conjunction with the first supporting portion, and the second pressure portion is installed in conjunction with the second supporting portion;

The pre-tensioning component is installed between the first pressure portion and the second supporting portion, while the button component is installed on the second supporting portion and connected to the second pressure portion. When the button component is closed, the second pressure portion applies tightening force towards the supporting wall to the first pressure portion and the first supporting portion installed in conjunction with it.

Further, the first supporting portion includes a supporting seat, and the second supporting portion includes a base, with the supporting seat and the base slidingly connected;

The first pressure portion comprises an sloping top block, which is installed within the supporting base. The sloping top block has second trapezoidal protrusion on its sides, while corresponding first trapezoidal protrusion are provided inside the supporting base. The second trapezoidal protrusion make contact with the first trapezoidal protrusion via inclined surface. The pre-tensioning component is a spring, with its ends fixed respectively to the sloping top block and the base. The pre-tension force provided by the spring causes the sloping top block to press the supporting base towards the supporting wall;

The second pressure portion comprises a square top block, which is positioned within a square hole in the base and can slide relative to the opening both inward and outward. The inner side of the square top block is equipped with the square top block sawteeth, while the outer side of the sloping top block is equipped with the sloping top block sawteeth;

The button component is installed on the base and connected to the square top block. When the button component is closed, it pushes the square top block inward. As a result, the square top block drives the sloping top block inward, and the square top block sawteeth engage with the sloping top block sawteeth. This arrangement prevents relative sliding between the sloping top block and the square top block, thereby generating an inclined surface force between them.

Further, the lower end of the supporting rail extends towards the roller blind mechanism to form a light-blocking plate. Additionally/alternatively, the end cap assembly and the roller blind installation mechanism are provided with anti-slip components at one end supported by the supporting wall.

Further, the roller blind body comprises a fabric and a lower rail assembly, with a groove provided at the lower end of the roller tube. The upper end of the fabric is clamped in the groove of the roller tube, and the lower rail assembly is positioned at the bottom of the fabric to provide vertical weight.

Compared to prior art, the invention offers the following beneficial effects:
1. The gap-adjustable, quick non-penetrating installation roller blind provided by this invention allows for the adjustment of the relative position of the curtain fabric using sliders and grooves, ensuring even gaps on the left and right sides of the curtain after installation.
2. The gap-adjustable, quick non-penetrating installation roller blind provided by this invention ensures the stability of the curtain fabric position by employing an interference fit between the sliders and grooves, along with a design incorporating tabs to prevent free sliding of the sliders within the grooves.
3. The gap-adjustable, quick non-penetrating installation roller blind provided by this invention further enhances convenience by incorporating a button-operated mechanism in the non-penetrating supporting structure. This mechanism allows for easy and quick installation with the push of a button, providing significant support within the range of manual operation.
4. The gap-adjustable, quick non-penetrating installation roller blind provided by this invention is compatible with both manual rope control systems and no-pull spring systems, making it versatile and widely applicable.

### BRIEF DESCRIPTION OF THE DRAWINGS

By reading the detailed description provided with reference to the drawings of non-limiting embodiment, other features, objectives, and advantages of the invention will become more apparent:

FIG. 1 is a schematic diagram of a gap-adjustable, quick non-penetrating installation roller blind According to embodiment 1;

FIG. 2 is an exploded view of the gap-adjustable, quick non-penetrating installation roller blind According to embodiment 1;

FIG. 3a is a structural schematic diagram of the rotating head in embodiment 1;

FIG. 3b is an exploded view of the rotating head in embodiment 1;

FIG. 4a is a structural schematic diagram of the first mounting bracket and the second mounting bracket from a first perspective in embodiment 1;

FIG. 4b is a structural schematic diagram of the first mounting bracket and the second mounting bracket from a second perspective in embodiment 1;

FIG. 5a is a structural schematic diagram of the roller blind installation mechanism in embodiment 1;

FIG. 5b is an exploded view of the roller blind installation mechanism in embodiment 1;

FIG. 6 is a structural schematic diagram of the supporting rail in embodiment 1;

FIG. 7 is a structural schematic diagram of the non-penetrating installation mechanism in embodiment 1;

FIG. 8 is an exploded view of the non-penetrating installation mechanism in embodiment 1;

FIG. 9a is a structural schematic diagram of the base included in the non-penetrating installation mechanism from a first perspective in embodiment 1;

FIG. 9b is a structural schematic diagram of the base included in the non-penetrating installation mechanism from a second perspective in embodiment 1;

FIG. 10 is a structural schematic diagram of the button included in the non-penetrating installation mechanism in embodiment 1;

FIG. 11 is a structural schematic diagram of the button bracket included in the non-penetrating installation mechanism in embodiment 1;

FIG. 12a is a structural schematic diagram of the supporting seat included in the non-penetrating installation mechanism from a first perspective in embodiment 1;

FIG. 12b is a structural schematic diagram of the supporting seat included in the non-penetrating installation mechanism from a second perspective in embodiment 1;

FIG. 13a is a structural schematic diagram of the sloping top block included in the non-penetrating installation mechanism from a first perspective in embodiment 1;

FIG. 13b is a structural schematic diagram of the sloping top block included in the non-penetrating installation mechanism from a second perspective in embodiment 1;

FIG. 14 is a structural schematic diagram of the connecting rod included in the non-penetrating installation mechanism in embodiment 1;

FIG. 15a is a structural schematic diagram of the square top block included in the non-penetrating installation mechanism from a first perspective in embodiment 1;

FIG. 15b is a structural schematic diagram of the square top block included in the non-penetrating installation mechanism from a second perspective in embodiment 1;

FIG. 16a is a structural schematic diagram of the end cap assembly in embodiment 1;

FIG. 16b is an exploded view of the end cap assembly in embodiment 1;

FIG. 17 is a schematic diagram of a gap-adjustable, quick non-penetrating installation roller blind According to embodiment 2;

FIG. 18 is an exploded view of the gap-adjustable, quick non-penetrating installation roller blind According to embodiment 2;

FIG. 19a is a structural schematic diagram of the first mounting bracket from a first perspective in embodiment 2;

FIG. 19b is a structural schematic diagram of the first mounting bracket from a second perspective in embodiment 2;

FIG. 20a is a structural schematic diagram of the locking rotating head in embodiment 2;

FIG. 20b is an exploded view of the locking rotating head in embodiment 2;

FIG. 21a is a structural schematic diagram of the no-pull spring system in embodiment 2;

FIG. 21b is an exploded view of the no-pull spring system in embodiment 2;

FIG. 22a is a structural schematic diagram of the damper in embodiment 2;

FIG. 22b is an exploded view of the damper in embodiment 2;

FIG. 23a is a structural schematic diagram of the unidirectionally pulley in embodiment 2;

FIG. 23b is an exploded view of the unidirectionally pulley in embodiment 2;

FIG. 24a is a structural schematic diagram of the first mounting bracket and the second mounting bracket from a first perspective in embodiment 3;

FIG. 24b is a structural schematic diagram of the first mounting bracket and the second mounting bracket from a second perspective in embodiment 3;

FIG. 25 is a structural schematic diagram of the locking component and the pulley assembly cooperation in embodiment 1.

### DESCRIPTION OF REFERENCE NUMERALS

1—Supporting rail
2—Non-penetrating installation mechanism
3—Roller blind lifting mechanism
4—First mounting bracket
5—Roller tube
6—Curtain fabric
7—Lower rail assembly
8—End cap assembly
9—Rotating head
10—Second mounting bracket
11—Opening
12—Rail groove
13—Light-blocking plate
14—Rail reinforcement rib
15—Spring piece
16—Base
17—Button
18—Button bracket
19—Button mounting shaft
20—Anti-slip component
21—Supporting seat
22—Sloping top block
23—Connecting rod
24—Square top block
25—Pre-tensioning component
26—Square hole
27—Limiting ribs
28—Base latch
29—Base slot
30—Button bracket mounting slot
31—Positioning cylinder
32—Base groove
33—Button body
34—Rod mounting hole
35—Button mounting hole
36—Cam
37—Shaft hole
38—Button bracket groove
39—Mounting rib
40—Anti-slip groove
41—Sliding rib
42—First trapezoidal protrusion
43—Supporting seat latch
44—Notch
45—Sloping top block sawteeth
46—Second trapezoidal protrusion
47—Sloping top block positioning shaft
48—Sloping top block reinforcement rib
49—First mounting shaft
50—Second mounting shaft
51—Motion groove
52—Sliding groove
53—Square top block sawteeth
54—End cap
55—End cap groove
56—End cap slot
57—Mounting protrusion
58—Rotating head positioning shaft
59—Rotating head sleeve
60—Limitation hole
61—Elastic latch
62—Rotating head mounting hole
63—Lifting mechanism housing
64—Lifting mechanism fixing shaft
65—Control rope
66—Rotating seat
67—Lifting mechanism mounting hole
68—Lifting mechanism pulley
69—Fixing clip
70—Locking component
71—Winding pulley
72—Slider
73—Installation bracket positioning column
74—Installation bracket reinforcement rib
75—First installation bracket
76—Locking Rotating head
77—No-pull spring system
78—Installation bracket positioning column
79—Locking sleeve
80—Locking fixing shaft
81—Semi-circular groove hole
82—Clamp
83—Locking groove
84—Track groove
85—Track ball
86—Rotating head
87—Fixed rod
88—Fixed rod mounting hole
89—Spring
90—Damper
91—Unidirectionally pulley
92—Screw
93—Damper housing
94—Damper cover
95—Worm shaft
96—Sealing gasket
97—Pulley body
98—Pulley cover
99—Rotating disk
100—Rotating shaft
200—Fixing mechanism
140—Roller blind mechanism
110—Roller blind mounting mechanism
120—Roller blind body
130—pulley assembly
150—supporting component
151—First supporting portion
152—Second supporting portion
160—Pressure component
161—First pressure portion
162—Second pressure portion
170—Button component
500—Roller blind with adjustable gap quick non-penetrating installation

### DETAILED DESCRIPTION OF THE PREFERRED EMBODIMENTS

To clarify the purpose, technical solution, and advantages of the embodiments described herein, the following detailed description of the embodiments provided in the accompanying drawings is presented. It is understood that the described embodiments are part of this application, and not all possible embodiments are depicted. Components shown and described in the drawings can be arranged and designed in various configurations.

Therefore, the detailed description of the embodiments provided in the drawings is not intended to limit the scope of the claims of this application, but only to represent selected embodiments thereof. All other embodiments obtained by those skilled in the art without creative labor based on the embodiments disclosed herein are within the scope of protection of this application.

It should be noted that similar numerals and letters in the following drawings represent similar elements. Therefore, once an element is defined in one drawing, it does not need to be further defined or explained in subsequent drawings. Additionally, all directional indications (such as up, down, left, right, front, rear, bottom, etc.) used in this application are for explaining the relative positional relationships and movements of the components in a specific orientation (as shown in the drawings). If this specific orientation changes, the directional indications also change Accordingly. Furthermore, descriptions involving “first,” “second,” etc., are used for descriptive purposes only and should not be construed to indicate or imply relative importance or the quantity of the indicated technical features.

### Embodiment 1

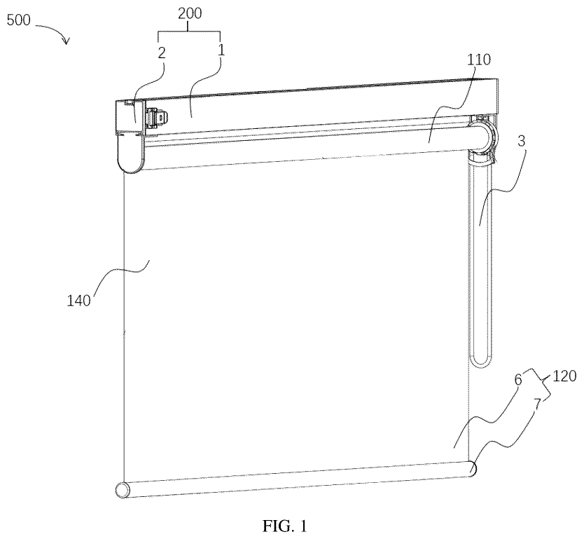

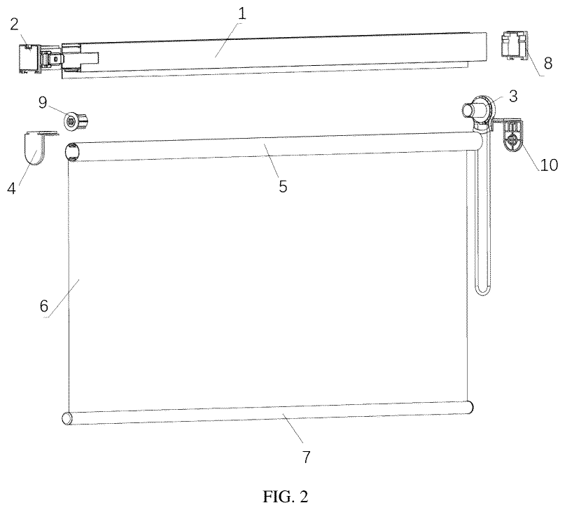

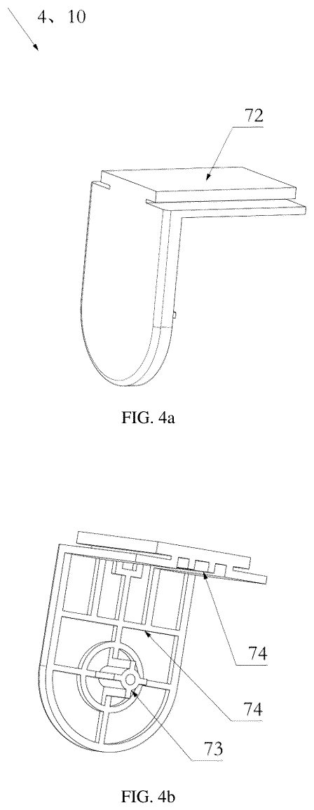

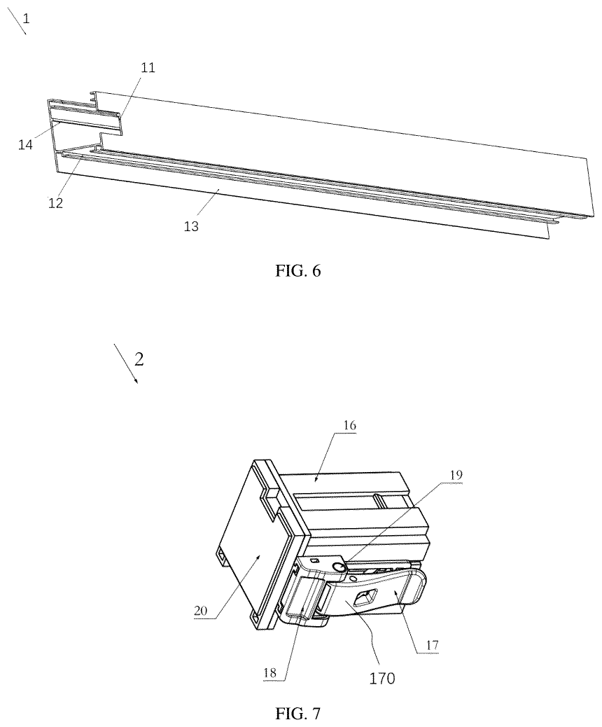

As shown in FIGS. 1 to 16 and FIG. 25, the present embodiment provides a gap-adjustable, quick non-penetrating installation roller blind 500. As shown in FIGS. 1 and 2, the roller blind 500 generally comprises a roller blind mechanism 140 and a fixing mechanism 200. The fixing mechanism 200 is supported between the supporting walls on both sides of the window, and the lower end of the roller blind mechanism 140 is slidably connected to the fixing mechanism 200. The fixing mechanism 200 includes a non-penetrating installation mechanism 2, a supporting rail 1, and an end cap assembly 8. The non-penetrating installation mechanism 2 and the end cap assembly 8 are arranged on both sides of the supporting rail 1, with the non-penetrating installation mechanism 2 achieving the non-penetrating installation of the supporting rail 1. The roller blind mechanism 140 is the main structure for covering the window, fixed below the supporting rail 1, and the supporting rail 1 has a rail groove 12 at one end (i.e., the lower end) facing the roller blind mechanism 140 (see FIG. 6). The upper end of the roller blind mechanism 140 has a slider 72 (see FIG. 4a), which, through the cooperation with the rail groove 12, enables lateral sliding relative to the supporting rail 1.

The gap-adjustable, quick non-penetrating installation roller blind 500 provided in this embodiment overcomes the technical issues of uneven gaps between the curtain fabric and window frame after curtain installation and the inability to tighten the non-penetrating installation by hand, as seen in traditional curtains. The roller blind 500 provided in this embodiment achieves adjustable gaps between the curtain fabric 6 and the window frame by utilizing the cooperation between the slider 72 of the roller blind mechanism 140 and the rail groove 12 of the fixing mechanism 200. Additionally, the non-penetrating installation mechanism 2 included in the fixing mechanism 200 allows for quick and easy installation without the need for drilling holes, thus enabling one-step installation of the roller blind 500 provided in this embodiment. The specific structural design of the gap-adjustable, quick non-penetrating installation roller blind 500 provided in this embodiment is as follows:

Regarding the design of the roller blind mechanism 140, as shown in FIG. 1, the roller blind mechanism 140 includes the roller blind installation mechanism 110, the roller blind body 120, and the roller blind lifting mechanism 3. The roller blind installation mechanism 110 is used to install the roller blind body 120 below the supporting rail 1 and allows the roller blind body 120 to slide relative to the supporting rail 1. The roller blind lifting mechanism 3 is fixed to the right side of the roller blind installation mechanism 110 and is used to control the raising and lowering of the roller blind body 120.

Regarding the design of the roller blind body 120, as shown in FIG. 1, the roller blind body 120 includes the curtain fabric 6 and the lower rail assembly 7. The curtain fabric 6 is a woven material used to cover the window. The lower rail assembly 7 consists of a lower rail and lower rail end caps. The lower rail is equipped with lower rail slots, and the lower end of the curtain fabric 6 is installed and fixed in the lower rail slots. The lower rail end caps are installed at both ends of the lower rail for decoration and to prevent the curtain fabric 6 from slipping out of the lower rail slots. The lower rail assembly 7 is positioned at the lower end of the curtain fabric 6 to provide gravitational force, thereby reducing the impact of wind or other external forces and ensuring the overall stability of the roller blind 500 provided in this embodiment during use.

Regarding the design of the roller blind installation mechanism 110, as shown in FIG. 2, the roller blind installation mechanism 110 includes the roller tube 5, the first mounting bracket 4, the second mounting bracket 10, and the rotating head 9. The roller tube 5 is a hollow structure with a curtain installation groove on top, where the upper end of the curtain fabric 6 is fixed to the roller tube 5 through the curtain installation groove. The roller tube 5 also has internal ribs at both ends, where the roller blind lifting mechanism 3 and the rotating head 9 are respectively installed. The overall shape of the first mounting bracket 4 is an inverted L-shape, with its horizontal right-angle plate serving as the slider 72 slidingly connected to the rail groove 12 of the supporting rail 1, and its vertical right-angle plate connected to the rotating head 9. The overall shape of the second mounting bracket 10 is the same as the first mounting bracket 4, with its horizontal right-angle plate serving as the slider 72 slidingly connected to the rail groove 12 of the supporting rail 1, and its vertical right-angle plate connected to the roller blind lifting mechanism 3. The aforementioned structural design allows the roller tube 5 to be slidably installed below the supporting rail 1 through the setting of the first mounting bracket 4 and the second mounting bracket 10. Moreover, users can control the rotation of the roller tube 5 through the roller blind lifting mechanism 3 installed at the right end of the roller tube 5, thereby winding or unwinding the curtain fabric 6 around the roller tube 5 to achieve the retraction or extension of the curtain fabric 6. Additionally, as shown in FIG. 4b, to ensure sufficient strength of the first mounting bracket 4 and the second mounting bracket 10, this embodiment also includes multiple mounting bracket reinforcement ribs 74 set on the inner sides of the first mounting bracket 4 and the second mounting bracket 10.

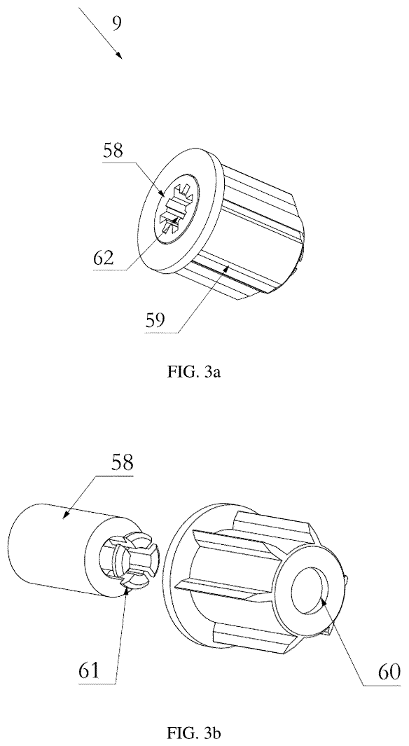

Regarding the connection of the first mounting bracket 4, the rotating head 9, and the left end of the roller tube 5, as shown in FIGS. 3a and 3b, the rotating head 9 comprises a rotating head positioning shaft 58 and a rotating head sleeve 59. The rotating head sleeve 59 is sleeved on the outer periphery of the rotating head positioning shaft 58 and can rotate relative to the rotating head positioning shaft 58. The first mounting bracket 4 is fixedly mounted to the rotating head positioning shaft 58, while the rotating head sleeve 59 is fixedly mounted to the left end of the roller tube 5. This arrangement allows for synchronous rotation of the left end of the roller tube 5 with the right end of the roller tube 5 when the right end of the roller tube 5 rotates under the drive of the roller blind lifting mechanism 3. Specifically:

Combining FIGS. 3a, 3b, 4a and 4b, the first mounting bracket 4 has installation bracket positioning column 73 on one side facing the rotating head positioning shaft 58. The rotating head positioning shaft 58 has rotating head mounting holes 62 on one side facing the first mounting bracket 4. The first mounting bracket 4 and the rotating head positioning shaft 58 are installed and fixed by the cooperation of installation bracket positioning column 73 and the rotating head mounting holes 62. To prevent relative rotation between the first mounting bracket 4 and the rotating head positioning shaft 58, the rotating head mounting holes 62 are equipped with cross slots, and correspondingly, the installation bracket positioning column 73 are also designed with a cross structure. This configuration ensures that after the installation bracket positioning column 73 are inserted into the rotating head mounting holes 62, they cannot rotate relative to each other, thus preventing relative rotation between the first mounting bracket 4 and the rotating head positioning shaft 58. Furthermore, several ribs are distributed on the outer side of the rotating head sleeve 59. These ribs cooperate with ribs set inside the left end of the roller tube 5 to install the rotating head sleeve 59 inside the left end of the roller tube 5 and prevent relative rotation between the rotating head sleeve 59 and the roller tube 5.

Regarding the rotational connection between the rotating head positioning shaft 58 and the rotating head sleeve 59, as shown in FIGS. 3a and 3b, the rotating head positioning shaft 58, away from the side facing the first mounting bracket 4, has an elastic latch 61. The rotating head sleeve 59 is a hollow structure with a limitation hole 60 formed at the tail end of the hollow structure. The rotating head positioning shaft 58 is inserted from the front end of the rotating head sleeve 59. Subsequently, the elastic latch 61 of the rotating head positioning shaft 58 passes through the hollow structure of the rotating head sleeve 59 and is engaged by the limitation hole 60, thereby achieving a rotational connection between the rotating head positioning shaft 58 and the rotating head sleeve 59 while preventing separation between them.

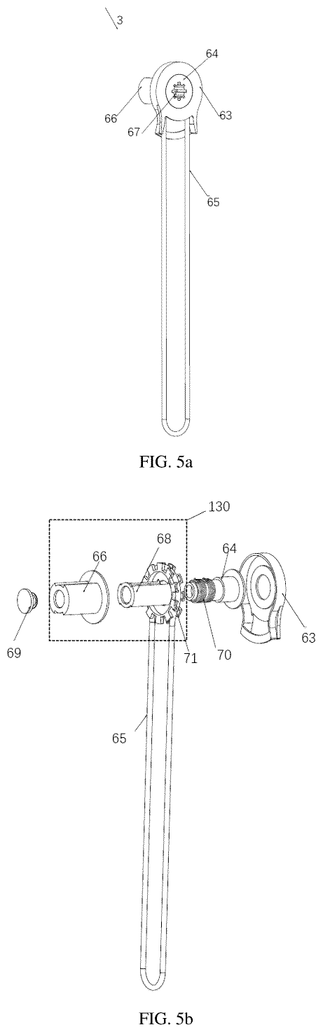

Regarding the connection between the roller blind lifting mechanism 3, the second mounting bracket 10, and the right end of the roller tube 5, as shown in FIGS. 5a and 5b, the roller blind lifting mechanism 3 includes a control rope 65, a lifting mechanism fixing shaft 64, and a pulley assembly 130. The pulley assembly 130 is rotatably sleeved on the lifting mechanism fixing shaft 64, and the control rope 65 is wound around the pulley assembly 130. As shown in FIGS. 4a and 4b, the overall shape of the second mounting bracket 10 is the same as that of the first mounting bracket 4. Its vertical right-angle plate is provided with a mounting bracket positioning column 73 facing the side of the roller blind lifting mechanism 3. Correspondingly, as shown in FIGS. 5a and 5b, the lifting mechanism fixing shaft 64 is provided with a lifting mechanism mounting hole 67 facing the side of the second mounting bracket 10. The second mounting bracket 10 and the lifting mechanism fixing shaft 64 are installed and fixed through the cooperation of the mounting bracket positioning column 73 and the lifting mechanism mounting hole 67. To prevent the second mounting bracket 10 from rotating relative to the lifting mechanism fixing shaft 64, the mounting bracket positioning column 73 of the second mounting bracket 10 is also designed as a cross structure. Correspondingly, the lifting mechanism mounting hole 67 is provided with cross-shaped recesses, preventing rotation after the installation of the second mounting bracket 10 and the lifting mechanism fixing shaft 64. Furthermore, the outer surface of the pulley assembly 130 is provided with grooves, which cooperate with the ribs set inside the right end of the roller tube 5. This ensures the fixed installation of the pulley assembly 130 to the right end of the roller tube 5, and prevents relative rotation after installation, allowing the pulley assembly 130 to rotate the roller tube 5 under the drive of the control rope 65.

Regarding the design of the roller blind lifting mechanism 3, specifically, as shown in FIGS. 5a and 5b, in this embodiment, the roller blind lifting mechanism 3 includes not only the lifting mechanism fixing shaft 64, the pulley assembly 130, and the control rope 65 mentioned above, but also the lifting mechanism housing 63, the fixing clip 69, and the locking component 70. The pulley assembly 130 includes the lifting mechanism pulley 68 and the rotating seat 66. The control rope 65 is a manipulation rope used to control the lifting of the curtain fabric 6. It is a looped rope wound around the pulley assembly 130. Under external force, the control rope 65 can rotate the pulley assembly 130, thereby driving the roller tube 5 to rotate. The lifting mechanism fixing shaft 64 serves as the central axis of the pulley assembly 130. It includes a cylindrical structure and a lifting mechanism mounting hole 67 set at the end of the cylindrical structure (i.e., the right end in FIG. 5a). The lifting mechanism fixing shaft 64 is fixedly installed on the second mounting bracket 10 through the cooperation of the lifting mechanism mounting hole 67 and the mounting bracket positioning column 73. The lifting mechanism pulley 68 is the active pulley driven by the control rope 67 to rotate around the lifting mechanism fixing shaft 64. It includes a hollow cylinder and a rope winding pulley 71 set at the end of the hollow cylinder (i.e., the right end in the FIG. 5b). Several teeth are distributed on the rope winding pulley 71 to allow the control rope 67 to be wound around it and prevent slippage relative to the lifting mechanism pulley 68. The hollow structure of the lifting mechanism pulley 68 forms a positioning hole, which is used to install in conjunction with the cylindrical lifting mechanism fixing shaft 64. The rotating seat 66 also includes a hollow cylinder, and it is sleeved on the outer periphery of the hollow cylinder of the lifting mechanism pulley 68. The front end of the lifting mechanism fixing shaft 64 (i.e., the cylinder of the lifting mechanism fixing shaft 64) passes through the hollow cylinder of the lifting mechanism pulley 68 and then passes out of the hollow cylinder of the rotating seat 66. The diameter of the fixing clip 69 is greater than the inner diameter of the hollow cylinder of the rotating seat 66. It is installed at the front end of the lifting mechanism fixing shaft 64, allowing the rotating seat 66 and the lifting mechanism pulley 68 to rotate relative to the lifting mechanism fixing shaft 64 while fixing the positions of the rotating seat 66, the lifting mechanism pulley 68, and the lifting mechanism fixing shaft 64 to prevent these components from separating.

As shown in FIG. 25, the locking component 70 includes a torsion spring, which utilizes the characteristic of the inner diameter changing when the torsion spring rotates in different directions to achieve locking. Specifically, the torsion spring is sleeved on the cylindrical portion of the lifting mechanism fixing shaft 64. The hollow cylinder of the lifting mechanism pulley 68 has slot holes, and corresponding raised platforms are set inside the hollow cylinder of the rotating seat 66. When the lifting mechanism pulley 68 rotates, the slot holes cooperate with the torsion spring arms, which are located on the outside of the torsion spring arms. The lifting mechanism pulley 68 drives the torsion spring to increase its inner diameter, causing the torsion spring to relax and allowing the lifting mechanism pulley 68 to rotate relative to the lifting mechanism fixing shaft 64. When the rotating seat 66 rotates, the raised platforms cooperate with the torsion spring arms, which are located on the inside of the torsion spring arms. This rotation causes the torsion spring to decrease its inner diameter, thereby locking relative to the lifting mechanism fixing shaft 64, preventing the rotating seat 66, which is engaged with the roller tube 5, from freely rotating, and locking the curtain in the required position.

Additionally, the outer side of the rotating seat 66 is provided with a groove, which cooperates with the ribs set inside the right end of the roller tube 5. This ensures that after the rotating seat 66 is connected to the roller tube 5 through the groove and ribs, they cannot rotate relative to each other, allowing the rotating seat 66 to drive the roller tube 5 to rotate. The lifting mechanism housing 63 covers the outer side of the lifting mechanism pulley 68 to prevent the control rope 65 from separating or falling off from the lifting mechanism pulley 68. One side of the lifting mechanism housing 63 is also provided with a housing positioning hole, which allows one end of the lifting mechanism fixing shaft 64 to pass through, and the lifting mechanism housing 63 is also provided with a rope passing hole underneath to allow the control rope 65 to pass through.

The above is about the specific structural design of the roller blind mechanism 140 contained in the roller blind 500 of this embodiment. The following elaborates on the specific design of the fixing mechanism 200 contained in the roller blind 500.

As shown in FIGS. 1 and 2, the fixing mechanism 200 overall comprises the non-penetrating installation mechanism 2, the supporting rail 1, and the end cap assembly 8. The non-penetrating installation mechanism 2 and the end cap assembly 8 are tightly attached to the supporting wall, and the supporting rail 1 is installed between the non-penetrating installation mechanism 2 and the end cap assembly 8. Regarding the supporting rail 1, as shown in FIG. 6, it includes a rail groove 12 at the lower end, which is used to connect and slide with the sliders 72 contained in the first installation bracket 4 and the second installation bracket 10 of the roller blind mechanism 140 mentioned above, enabling the roller blind mechanism 140 to horizontally slide relative to the supporting rail 1. To prevent the roller blind mechanism 140 from freely sliding relative to the supporting rail 1 under non-human forces (such as wind), the embodiment designs the cooperation between the slider 72 and the rail groove 12. Since the rail groove 12 is typically made of materials such as aluminum profiles, PVC, or metal, with a relatively thin wall thickness and certain deformation resistance, making the width of the slider 72 slightly larger than the opening width of the rail groove 12 (for example, 0 to 0.1 mm) can create an interference fit relationship between the slider 72 and the rail groove 12 after installation, providing resistance greater than typical wind forces, thus preventing the roller blind mechanism 140 from freely sliding relative to the supporting rail 1 under non-human control. The left end of the supporting rail 1 is provided with an opening 11 for cooperation with the non-penetrating installation mechanism 2; and the lower end of the supporting rail 1 extends towards the roller blind mechanism 140 to form a light-blocking plate 13, which is used to block the gap between the supporting rail 1 and the roller tube 5, making the roller blind 500 provided in this embodiment more aesthetically pleasing during use. Additionally, to enhance the strength of the supporting rail 1, the embodiment sets track reinforcement ribs 14 on the supporting rail 1 to increase its strength and reduce the probability of deformation.

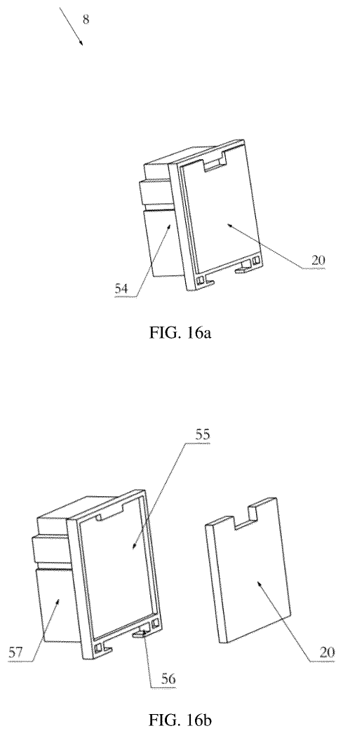

Regarding the design of the end cap assembly 8, as shown in FIGS. 16a and 16b, the end cap assembly 8 is installed at the right end of the supporting rail 1, flush against the supporting wall. The end cap assembly 8 comprises an end cap 54 and an anti-slip component 20. The end cap 54 is equipped with an mounting protrusion 57, the shape of which corresponds to the inner shape of the right end of the supporting rail 1. The end cap 54 is inserted into the right end of the supporting rail 1 by fitting the mounting protrusion 57. One end of the end cap 54 facing the supporting wall is provided with an end cap groove 55, where the anti-slip component 20 is installed to make contact with the supporting wall, preventing the roller blind mechanism 140 from sliding relative to the supporting wall after non-penetrating installation. Additionally, the lower end of the end cap 54 is equipped with an end cap slot 56, which is used to position and install the slider 72 of the second installation bracket 10. This allows the slider 72 of the second installation bracket 10 to slide relative to the end cap assembly 8 without obstruction when adjusting the gap of the curtain fabric 6.

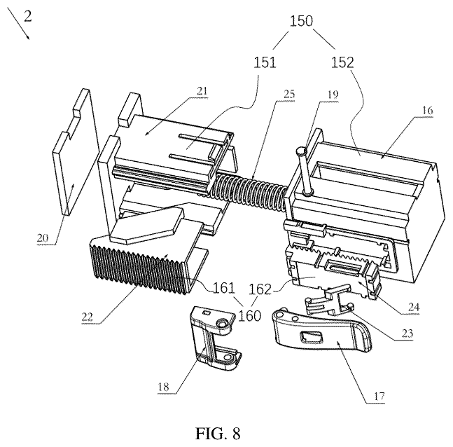

As shown in FIGS. 7 and 8, the non-penetrating installation mechanism 2 comprises, overall, the anti-slip component 20, the pre-tensioning component 25, the supporting component 150, the pressure component 160, and the button component 170. The supporting component 150 includes the first supporting portion 151 and the second supporting portion 152, which are relatively slidable. The first supporting portion 151 is oriented towards one side facing the support wall (the left side in FIG. 8), where the anti-slip component 20 is installed to prevent sliding against the support wall during non-penetrating installation. The second supporting portion 152 is connected to one side of the supporting rail 1 (the right side in FIG. 8). The pressure component 160 consists of the first pressure portion 161 and the second pressure portion 162. The first pressure portion 161 is mounted with the first supporting portion 151, and the second pressure portion 162 is mounted with the second supporting portion 152. The pre-tensioning component 25 is positioned between the first pressure portion 161 and the second supporting portion 152 to provide pre-tensioning force during non-penetrating installation. The button component 170 is installed on the side of the second supporting portion 152 facing the user and is connected to the second pressure portion 162. When the button component 170 is closed, it applies pressure to the second pressure portion 161, pushing it towards the first pressure portion 161 and thereby exerting pressure towards the support wall.

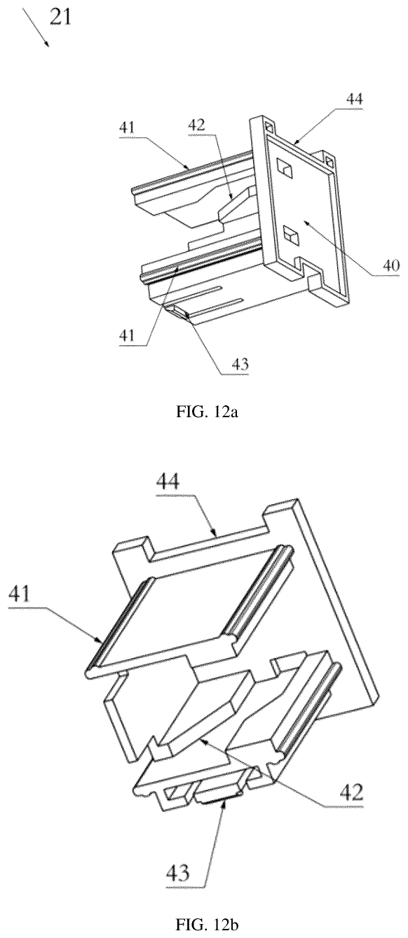

Specifically, as shown in FIG. 8, the first supporting portion 151 comprises a supporting seat 21. As shown in FIG. 12a, the supporting seat 21 has an anti-slip groove 40 on the side facing the wall support surface. The anti-slip component 20 is installed within this anti-slip groove 40. During installation of the curtain 500, the anti-slip component 20 contacts the support wall to prevent relative sliding between the curtain 500 and the support wall. The anti-slip component 20 is preferably made of silicone pad.

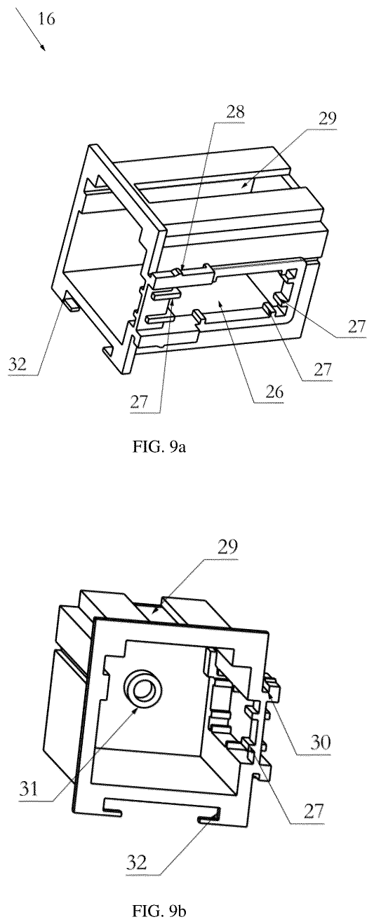

As shown in FIGS. 7 and 8, the second supporting portion 152 comprises a base 16, which serves as the housing of the non-penetrating installation mechanism 2 and is installed at the left end of the supporting rail 1. Referring to FIG. 12b, the supporting seat 21 extends from one side facing away from the support wall, with a supporting base sliding rib 41 in contact with the inner wall of the base 16. The supporting base 21 and the base 16 can slide relative to each other via the supporting base sliding rib 41. A supporting seat latch 43 is provided on the supporting base 21, and as shown in FIGS. 9a and 9b, a corresponding base groove 29 is provided at the corresponding position of the base 16. The supporting seat latch 43 and the base slot 29 are installed together to provide limiting action, preventing the supporting base 21 from separating from the base 16 due to excessive sliding distance.

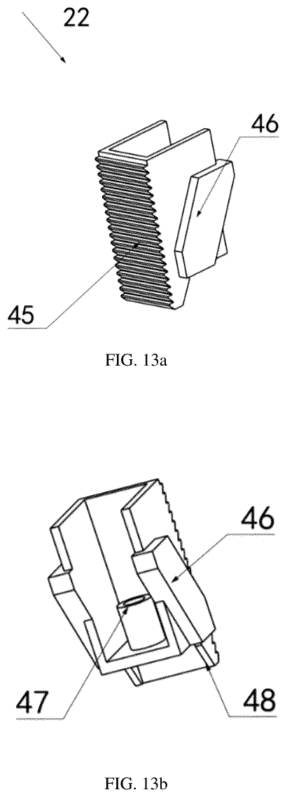

As shown in FIG. 8, the first pressure portion 161 comprises an sloping top block 22, which is installed inside the supporting base 21. Referring to FIGS. 13a and 13b, the sloping top block 22 has second trapezoidal protrusion 46 on both sides. Correspondingly, as shown in FIGS. 12a and 12b, there are two first trapezoidal protrusion 42 inside the supporting base 21. The second trapezoidal protrusion 46 of the sloping top block 22 make contact with the first trapezoidal protrusion 42 of the supporting base 21 via inclined surfaces. When the sloping top block 22 is subjected to pressure towards the support wall, the second trapezoidal protrusion 46 of the sloping top block 22 move towards the support wall direction with the assistance of the first trapezoidal protrusion 42 of the supporting base 21. This creates an inclined surface force between the second trapezoidal protrusion 46 and the first trapezoidal protrusion 42, thereby pressing the supporting base 21 against the support wall. To strengthen the sloping top block 22, sloping top block reinforcement ribs 48 are provided, as shown in FIG. 13b.

Furthermore, as shown in FIGS. 9b and 13b, the sloping top block 22 is equipped with an sloping top block positioning shaft 47, while the base 16 is equipped with a positioning cylinder 31. The two ends of the pre-tensioning component 25 are respectively positioned and installed on the positioning shaft 47 and the positioning cylinder 31. The pre-tensioning component 25 is a cylindrical spring that provides pre-tensioning force, urging the sloping top block 22 to press the supporting base 21 towards the support wall.

As depicted in FIG. 8, the second pressure portion 162 comprises a square top block 24. Referring to FIGS. 15a and 15b, the square top block 24 is equipped with a motion groove 51. Correspondingly, as shown in FIG. 9a, the base 16 is equipped with square holes 26 for installing the square top block 24. The inner periphery of the square holes 26 is provided with several base limiting ribs 27. The square top block 24 and the base 16 are connected via sliding by the cooperation between the motion groove 51 and the base limiting ribs 27.

Combined with FIGS. 8, 13a, and 15b, the inner side of the square top block 24 is equipped with square top block sawteeth 53, while the outer side of the sloping top block 22 is equipped with sloping top block sawteeth 45. One side of the supporting base 21 has an opening, allowing the sloping top block sawteeth 45 to be exposed externally. When the sloping top block sawteeth 45 engage with the square top block sawteeth 53, relative displacement between the sloping top block 22 and the square top block 24 is prevented.

As shown in FIGS. 7 and 8, the button component 170 consists of a button bracket 18, button 17, connecting rod 23, and button mounting shaft 19. The button bracket 18 is installed at the front opening of the base 16 (Note: the front refers to the side facing the operator during non-support installation). The button 17 is a component for quickly tightening the non-penetrating installation of the installation mechanism 2. It rotates relative to the button bracket 18 through the button mounting shaft 19. The connecting rod 23 is connected to the button 17 and slides relative to the square top block 24. When the button 17 is closed to perform non-penetrating installation, the button 17 rotates relative to the button bracket 18 around the button mounting shaft 19, pushing the connecting rod 23 inward and pushing the square top block 24. The square top block 24 slides inside the base 16 due to the cooperation between the motion groove 51 and the base limiting ribs 27. As the sawteeth of the square top block 24 and the sloping top block 22 engage, preventing their relative movement, the pressure applied to the square top block 24 is transmitted to the sloping top block 22, causing it to press the supporting base 21 against the support wall. When the button 17 is opened to release the non-penetrating installation, the button 17 moves the square top block 24 outward, separating it from the sloping top block 22, allowing them to move relative to each other.

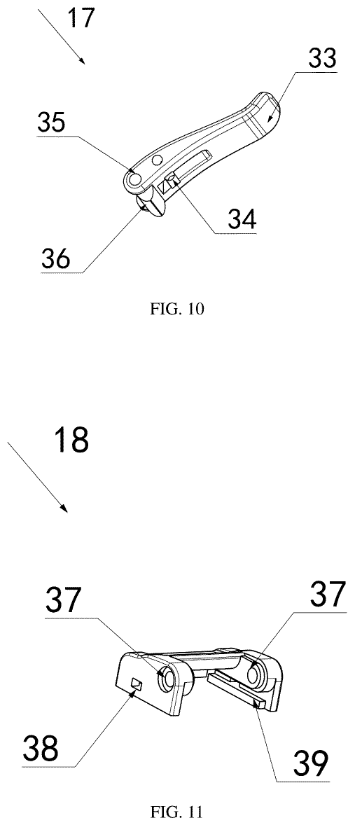

Specifically, as shown in FIG. 9b, the outer edge of the square hole 26 in the base 16 is equipped with a button bracket mounting groove 30. As shown in FIG. 11, the button bracket 18 has button bracket mounting ribs 39. The button bracket mounting ribs 39 on the button bracket 18 are installed in cooperation with the button bracket mounting groove 30 on the base 16, thereby preventing relative sliding between the button bracket 18 and the base 16. Additionally, the button bracket 18 has button bracket slots 38 on both sides, and corresponding positions on the base 16 are equipped with base latch 28. The button bracket groove 38 on the button bracket 18 are installed in cooperation with the base latch 28 on the base 16, preventing separation between the button bracket 18 and the base 16 after installation. Two shaft holes 37 are also set on the button bracket 18. As shown in FIG. 10, corresponding positions on the button 17 are equipped with button mounting holes 35. The button mounting shaft passes through the shaft holes 37 and the button mounting holes 35, connecting the button 17 to the button bracket 18. The button 17 can rotate relative to the button bracket 18 via the button mounting shaft, which can be a metal rivet. As shown in FIG. 10, the rotating end of the button 17 is equipped with a cam 36, which is at a certain angle of deviation from the axis of the button mounting shaft. The free end of the button 17 is the button body 33, which users can apply pressure or pull force to, thereby causing the cam 36 to rotate. During non-punching support, pressing the button 17 prevents it from rotating back, and when the cam 36 rotates, it contacts the square top block 24, thereby pushing the square top block 24 to move.

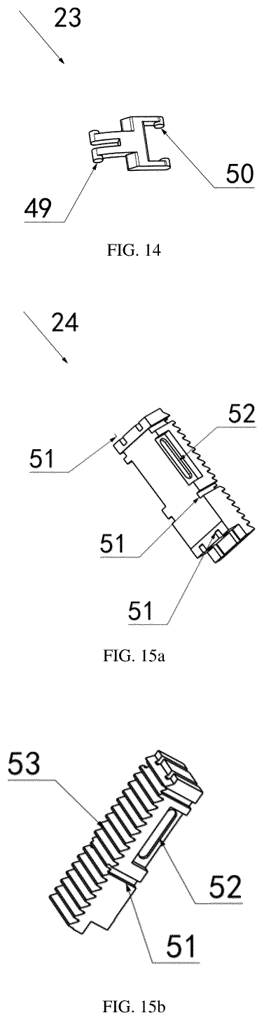

As shown in FIG. 14, the connecting rod 23 is a component that connects the button 17 and the square top block 24. One end of the connecting rod 23 is equipped with the first mounting shaft 49, and the other end is equipped with the second mounting shaft 50. Correspondingly, as shown in FIG. 10, the button 17 is equipped with a connecting rod mounting hole, and the connecting rod 23 is installed with the button 17 through the mounting cooperation of the first mounting shaft 49 and the connecting rod mounting hole. Additionally, as shown in FIGS. 15a and 15b, the sides of the square top block 24 are equipped with sliding grooves 52. The second mounting shaft 50 of the connecting rod 23 is installed inside the sliding grooves 52, allowing the connecting rod 23 to be connected to the square top block 24 and enabling the connecting rod 23 to slide relative to the square top block 24. When the button 17 is opened, releasing the non-penetrating support, the connecting rod 23 moves under the action of the button 17, thereby driving the square top block 24 to move outward, relieving the pressure of the square top block 24 on the sloping top block 22. When the button 17 is closed to initiate the non-penetrating support, the button 17 drives the connecting rod 23 to move inward, and the square top block 24 causes the sloping top block 22 to press the supporting seat 21 towards the supporting wall.

Furthermore, as shown in FIGS. 9a and 9b, the bottom end of the base 16 is also equipped with a base groove 32, which serves as an extension of the rail groove 12 for the sliding of the slider 72 of the first mounting bracket 4. Additionally, as shown in FIGS. 12a and 12b, one end of the supporting seat 21 is also equipped with a notch 44 on the outer side, allowing the first mounting bracket 4 to pass through the supporting seat 21 when sliding.

### Embodiment 2

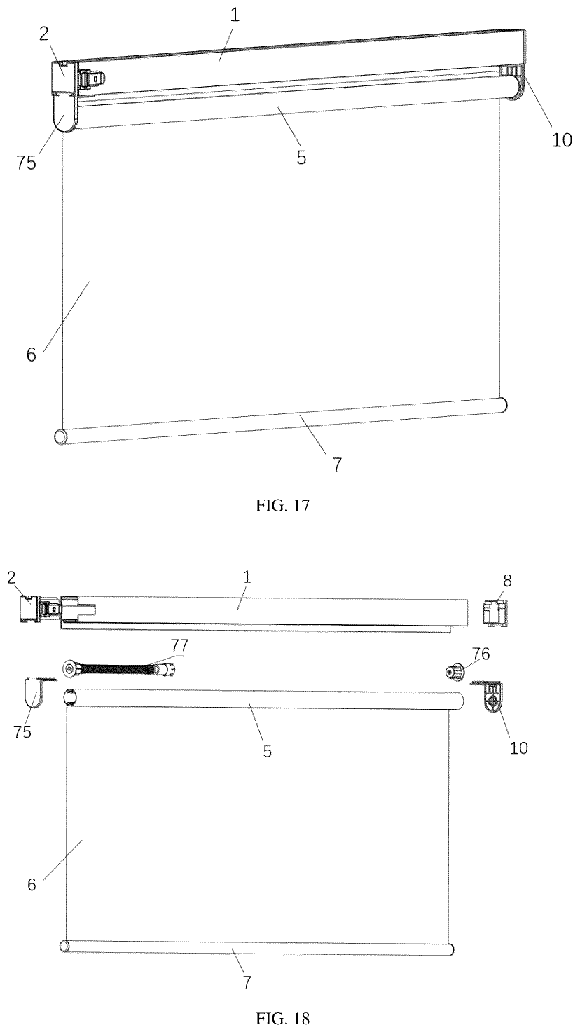

FIGS. 17 to 23 illustrate a type of gap-adjustable quick non-penetrating installation roller blind 500 provided in this embodiment. The main difference between this embodiment and the embodiment 1 lies in the different mechanisms for controlling the roller blind's rising and lowering. In embodiment 1, the primary mechanism for controlling the roller blind's movement is the control rope 65 and the rotating pulley assembly 130 driven by it. However, in this embodiment, the main mechanism for controlling the roller blind's movement is the no-pull spring system 77 and the locking head 76. In contrast to embodiment 1, this embodiment does not require the use of a pull rope for control. During operation, it is only necessary to pull the curtain fabric 6 to the desired position to lock it, then pull down again to unlock it, after which the curtain fabric 6 automatically ascends due to the spring force.

As the basic framework structure of the quick non-penetrating installation roller blind roller blind 500 provided in this embodiment is the same as that of embodiment 1, the same content will not be reiterated here. The following will focus on the design differences between this embodiment and embodiment 1, mainly the no-pull spring system 77 and the locking head 76, as well as the slight adjustments made to the first installation bracket 75 to accommodate the no-pull spring system 77.

As shown in FIGS. 17 and 18, the roller blind lifting mechanism 500 provided in this embodiment includes a no-pull spring system 77 and a locking head 76. Overall, the no-pull spring system 77 is installed on the left side of the roller tube 5, while the locking head 76 is installed on the right end of the roller tube 5. The no-pull spring system 77 is installed in coordination with the first installation bracket 75, and it drives the rotation of the roller tube 5 through spring torque to raise or lower the fabric 6. The locking head 76 is installed in coordination with the second mounting bracket 10, and it is used for locking or unlocking during the rotation of the roller tube 5.

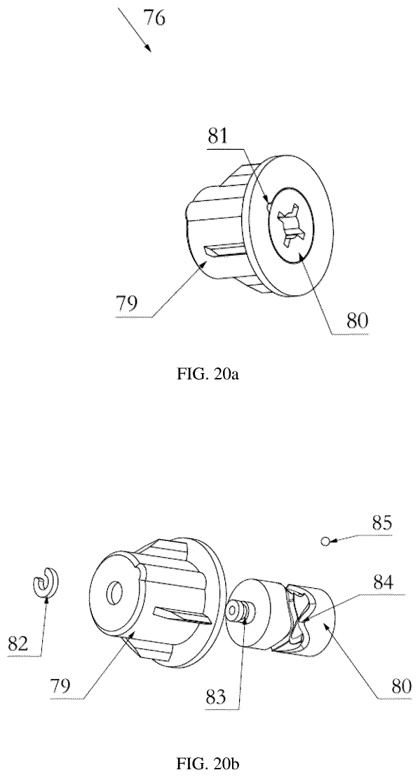

Regarding the design of the locking head 76, as shown in FIGS. 20a and 20b, it comprises a locking sleeve 79, a locking fixing shaft 80, a clamp 82, and a track ball 85. The locking sleeve 79 is sleeved onto the outer side of the locking fixing shaft 80, and it can rotate relative to the locking fixing shaft 80. The locking sleeve 79 is fixedly installed at the end of the roller tube 5, while the locking fixing shaft 80 is fixedly installed with the second mounting bracket 10. This arrangement allows the roller tube 5 to rotate using the rotation of the locking sleeve 79 relative to the locking fixing shaft 80. Specifically:

The locking fixing shaft 80 is located at the center of the locking sleeve 79, with one end protruding from the locking sleeve 79. The protruding end is designed with a locking groove 83, which is installed with the clamp 82. The dimensions of the clamp 82 are larger than the opening size provided by the locking sleeve 79 for the locking fixing shaft 80 to pass through. This design allows the locking sleeve 79 and the locking fixing shaft 80 to be assembled together without hindering the rotation of the locking sleeve 79 around the locking fixing shaft 80. Several ribs are distributed on the outer side of the locking sleeve 79, and these ribs cooperate with the ribs on the inner side of the end of the roller tube 5 to fix the locking sleeve 79 and the roller tube 5 in place, preventing relative movement between them. Furthermore, the locking fixing shaft 80 has a cross-shaped locating mounting hole on the side facing the second mounting bracket 10. The second mounting bracket 10 has installation bracket positioning column 73 on the side facing the locking fixing shaft 80. The locking fixing shaft 80 and the second mounting bracket 10 are installed and fixed together through the cooperation of the locating mounting hole and Installation bracket positioning columns 73, preventing relative rotation between them.

Additionally, regarding how the locking head 76 achieves automatic locking, as shown in FIGS. 20a and 20b, the outer surface of the locking fixing shaft 80 is provided with a track groove 84, which has a semi-circular cross-section. The track ball 85 moves along the track groove 84, and the corresponding position of the inner bore wall of the locking sleeve 79 is provided with a semi-circular groove hole 81, allowing the track ball 85 to move on it. When pulling down the curtain fabric 6, the roller tube 5 rotates, causing the locking sleeve 79 to rotate around the locking fixing shaft 80. The track ball 85 moves along the semi-circular groove hole 81 inside the locking sleeve 79 and, under the action of the locking sleeve 79, moves along the track groove 84 of the locking fixing shaft 80. When stopping pulling the fabric 6, the roller tube 5 rotates back under the action of the no-pull spring system 77, and the track ball 85, driven by the locking sleeve 79, rotates back along the track groove 84 until it falls into a limiting recess of the track groove 84, thus locking the mechanism. Pulling down the curtain fabric 6 again can release the lock.

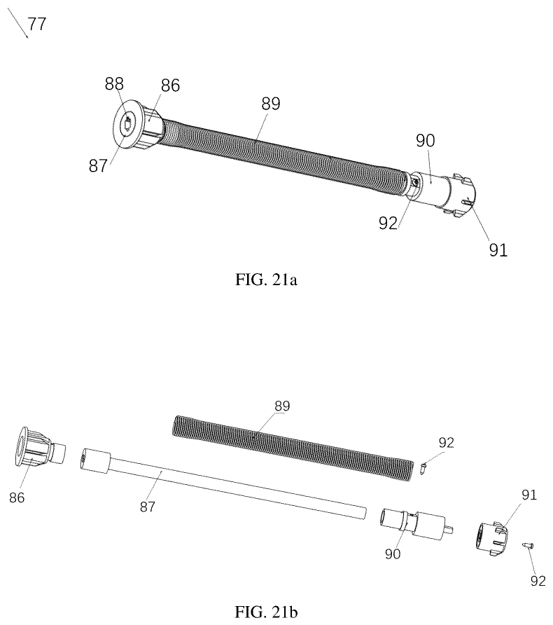

As for the design of the no-pull spring system 77, as shown in FIGS. 21a and 21b, it consists of the rotating head 86, the fixed rod 87, the spring 89, the damper 90, the unidirectionally pulley 91, and the screw 92. The spring 89 is mounted on the fixed rod 87, with its left end fixedly installed with the first installation bracket 75, and its right end fixedly installed with the damper 90. The rotating head 86 is installed on the inner side of the roller tube 5 and sleeved on the left end of the fixed rod 87, allowing it to rotate around the left end of the fixed rod 87 driven by the roller tube 5. The spring 89 is a helical spring, with its two ends fixed respectively on the rotating head 86 and the damper 90. The damper 90 is assembled with the unidirectionally pulley 91. When the curtain fabric 6 descends, the unidirectionally pulley 91 rotates with the roller tube 5, driving the damper 90 to provide damping. When the curtain rises, the unidirectionally pulley 91 rotates freely with the roller tube 5, while the damper 90 remains stationary. This allows the left end of the spring 89 to rotate along with the roller tube 5 and the rotating head 86 when the roller tube 5 rotates in the downward direction, increasing the torsion of the spring 89. In this process, the damper 90 moves under the action of the unidirectionally pulley 91 to provide damping, thereby preventing excessive tension from causing the curtain fabric 6 to be pulled down too quickly. When the roller tube 5 rotates in the upward direction along with the curtain fabric 6, the torsion of the spring 89 is released, allowing the roller tube 5 to rotate back. During this process, the unidirectionally pulley 91 rotates freely with the roller tube 5, while the damper 90 remains stationary. Specifically:

As shown in FIGS. 21a and 21b, the rotating head 86 is installed at the left end of the roller tube 5, moving synchronously with it. The rotating head 86 has a mounting hole for the head, through which the left end of the fixed rod 87 passes before being installed together with the rotating head 86. The rotating head 86 can rotate around the axis of the fixed rod 87. The tail end of the rotating head 86 (i.e., the right end in FIG. 21a) is equipped with a spring mounting hole, where the left end of the spring 89 is fixed. The rotating head 86 rotates with the roller tube 5, thereby generating or releasing torsional force in the spring 89. The left end of the fixed rod 87 is installed together with the rotating head 86, and its end also has a fixed rod mounting hole 88. The left end of the fixed rod 87 is installed in conjunction with the installation bracket positioning column 78 of the first installation bracket 75 through the fixed rod mounting hole 88, preventing the fixed rod 87 from rotating relative to the first installation bracket 75.

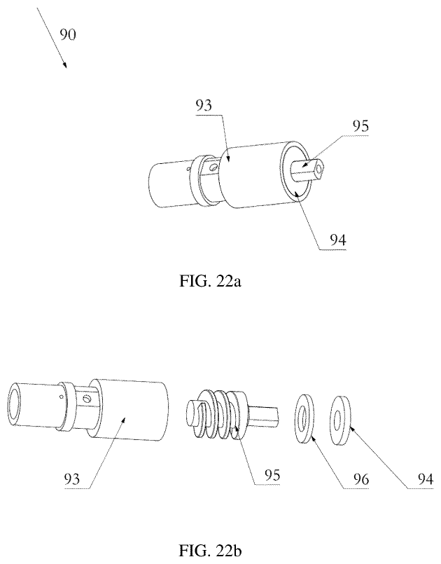

As shown in FIGS. 22a and 22b, the damper 90 consists of a damper housing 93, a worm shaft 95, a sealing gasket 96, and a damper cover 94. One end of the damper housing 93 is equipped with a damper mounting hole, which is used to install it in conjunction with the right end of the fixed rod 87. The damper housing 93 also has screw holes through which the damper housing 93 can be fixed together with the fixed rod 87 using screws 92. The damper housing 93 also has circular holes for securing the right end of the spring 89.

The worm shaft 95 is installed inside the damper housing 93 and is overall worm-shaped. One end of the worm shaft 95 is equipped with a convex platforms, which is installed in conjunction with the unidirectionally pulley 91. The interior of the damper housing 93 is filled with grease, causing resistance when the worm shaft 95 rotates. The sealing gasket 96 is located at one end of the worm shaft 95, with a circular hole allowing the convex platforms at one end of the worm shaft 95 to pass through it. The sealing gasket 96 seals to prevent grease leakage. Additionally, the right end of the damper housing 93 has an annular groove, where the damper cover 94 is installed to secure the worm shaft 95 and sealing gasket 96 inside the damper housing 93.

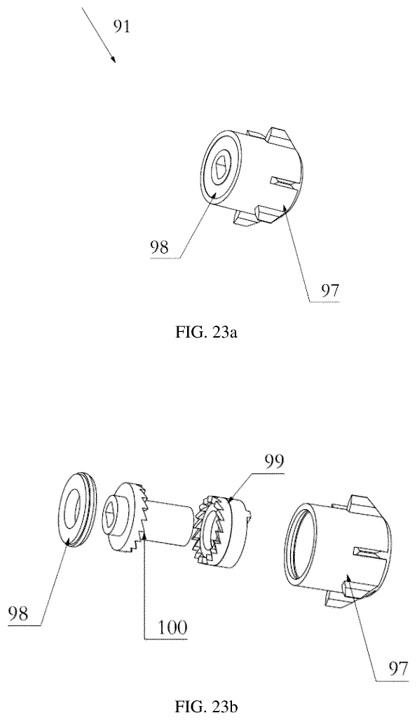

Regarding the design of the unidirectionally pulley 91, as shown in FIGS. 23a and 23b, the unidirectionally pulley 91 is installed together with the damper 90 and includes: the pulley body 97, pulley cover 98, shaft 100, and rotating disk 99. The pulley body 97 is located on the outer side of the unidirectionally pulley 91 and is installed inside the roller tube 5. The pulley body 97 has several notches on its outer surface to engage with the ribs inside the roller tube 5, enabling synchronous movement with the roller tube 5. One end of the shaft 100 is connected to the damper 90, and it has a mounting hole that aligns with the convex platforms on the damper 90, which can be secured with a screw 92. The rotating disk 99 is placed inside the pulley body 97 and fits around the shaft 100. The bottom of the pulley body 97 has a tapered surface that matches with the rotating disk 99, and the shaft 100 has a gear disk with oblique teeth. These teeth engage with the oblique teeth on the rotating disk 99 to enable rotation in one direction and separation in the opposite direction, achieving unidirectionally transmission. This design ensures that when the curtain fabric 6 is pulled down, the pulley body 97 rotates with the roller tube 5, causing the rotating disk 99 to engage with the shaft 100 under the action of the tapered surface, enabling synchronous rotation. When the curtain fabric 6 is rolled up, the pulley body 97 rotates in the opposite direction, causing the rotating disk 99 to disengage from the shaft 100, which remains stationary. Additionally, the pulley body 97 has a groove, and the pulley cover 98 fits into this groove to secure the shaft 100 and rotating disk 99 inside the pulley body 97, with a circular hole on the pulley cover 98 allowing one end of the shaft 100 to pass through it.

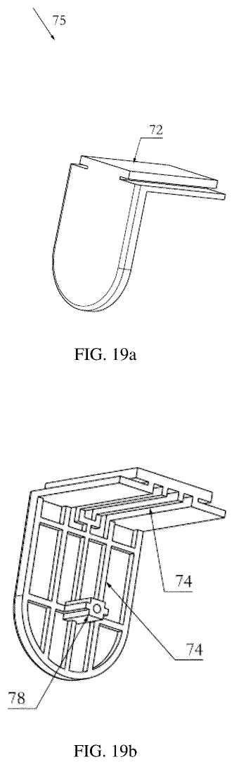

As for the first installation bracket 75 in this embodiment, as shown in FIGS. 19a and 19b, it is installed below the supporting rail 1 and is coordinated with the no-pull spring system 77 to be installed at one end of the roller tube 5. Its basic structure is the same as the first mounting bracket 4 in embodiment 1, with the difference lying in the shape of its mounting bracket positioning column 78, which differs from embodiment 1. In this embodiment, the shape of the installation bracket positioning column 78 is rectangular and includes ribs, thus accommodating the mounting hole 88 of the fixed rod 87 contained in the no-pull spring system 77.

### Embodiment 3

This embodiment provides a type of gap-adjustable, quick non-penetrating installation roller blind 500, with its main difference from the roller blind provided in embodiment 1 lying in the different methods used to prevent the first/second mounting bracket from freely sliding along the rail groove 12. In the first embodiment, the roller blind mechanism 140, under non-human control, is prevented from sliding relative to the supporting rail 1 by the interference fit relationship between the sliders 72 contained within the first/second mounting brackets and the rail groove 12.

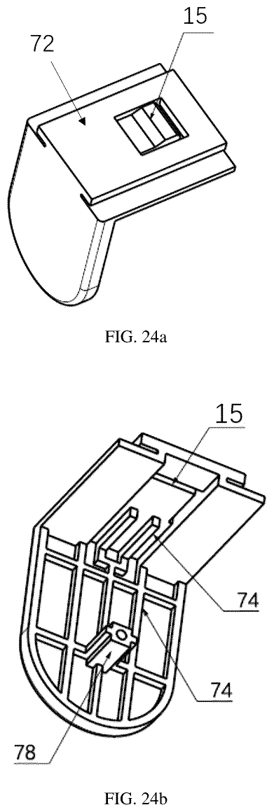

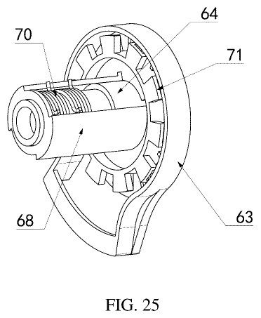

In this embodiment, as shown in FIGS. 24a and 24b, the upper surface of the sliders 72 of the first/second mounting brackets is equipped with spring piece 15. When the first/second mounting brackets are installed onto the rail groove 12, these spring piece 15 come into contact with the sliding surface of the rail groove 12 and exert pressure on it through their own elasticity, thereby causing the sliders 72 of the first/second mounting brackets to generate a certain resistance against the supporting rail 1, achieving the purpose of preventing their free sliding.

The above description provides specific embodiments of the invention. Based on the explanations provided, those skilled in the art can make various changes and modifications without departing from the scope of the technical principles of the invention.

What is claimed is:

1. A gap-adjustable, quick non-penetrating installation roller blind comprising:
a roller blind mechanism and a fixing mechanism, and the fixing mechanism is supported between supporting walls on both sides of the window, and the lower end of the roller blind mechanism is slidably connected to the fixing mechanism;
the fixing mechanism includes a non-penetrating installation mechanism, a supporting rail, and an end cap assembly, the non-penetrating installation mechanism and the end cap assembly are located on both sides of the supporting rail, the non-penetrating installation mechanism is used to enable the supporting rail to be fixed without drilling holes, and a groove is provided at the lower end of the supporting rail;
the roller blind mechanism is installed below the supporting rail, with a slider at the upper end, achieving lateral sliding relative to the supporting rail through the cooperation between the slider and the groove, the slider and the groove avoid free sliding through either of the following two methods:
the slider engages with the groove through an interference fit;
the upper surface of the slider is equipped with spring pieces, which come into contact with the sliding surface of the groove and exert pressure on the groove through their own elastic force.

2. According to claim 1, the gap-adjustable, quick non-penetrating installation roller blind, wherein:
the roller blind mechanism comprises a roller blind installation mechanism and a roller blind body, and the roller blind installation mechanism mounts the roller blind body below the supporting rail;
the roller blind installation mechanism comprises a roller tube, a first mounting bracket, and a second mounting bracket, the upper end of the roller blind body is fixed to the roller tube, and the roller tube rotates in cooperation with the first and second mounting brackets, each of which has a slider that engages with the groove on the supporting rail, enabling lateral sliding of the roller blind mechanism relative to the supporting rail.

3. According to claim 2, the gap-adjustable, quick non-penetrating installation roller blind, wherein the first and second mounting brackets have identical inverted L-shaped structures, the horizontal right angle edges of the first and second mounting brackets form sliders, while their vertical right angle edges rotate in cooperation with the ends of the roller tube.

4. According to claim 2, the gap-adjustable, quick non-penetrating installation roller blind wherein:
the roller blind mechanism further comprises a roller blind lifting mechanism for controlling the raising and lowering of the roller blind body;
the roller blind lifting mechanism includes a control rope, a fixing shaft, and a pulley assembly, the pulley assembly is mounted on the fixing shaft and fixedly installed at one end of the roller tube;
the control rope winds around the pulley assembly, and under external force, the control rope rotates the pulley assembly relative to the fixing shaft, which in turn rotates the roller tube, thereby raising or lowering the roller blind body.

5. According to claim 4, the gap-adjustable, quick non-penetrating installation roller blind wherein:
the roller blind lifting mechanism further comprises a locking mechanism in the roller blind lifting mechanism, including several torsion springs sleeved on the fixing shaft, the pulley assembly comprises a pulley and a pulley seat, the pulley includes a rope winding pulley and a pulley cylinder, the pulley cylinder is rotatably mounted on the outer periphery of the fixing shaft, and the pulley seat is then sleeved on the outer periphery of the pulley;
the pulley cylinder is provided with groove holes, which cooperate with the torsion springs so that when the pulley rotates, the torsion springs relax, causing the pulley to rotate relative to the fixing shaft, corresponding positions inside the pulley seat are provided with convex platforms, which cooperate with the torsion springs so that when the rotating seat rotates, the locking component tightens, thereby stopping the rotation of the rotating seat.

6. According to claim 2, the gap-adjustable, quick non-penetrating installation roller blind wherein:
the roller blind mechanism further comprising a roller blind lifting mechanism for controlling the raising and lowering of the roller blind body;
the roller blind lifting mechanism includes a no-pull spring system and a locking head, both installed at the ends of the roller tube, the no-pull spring system rotates the roller tube under spring torque, while the locking head controls the locking and unlocking of the roller tube;
the locking head comprises a locking sleeve, a locking fixing shaft, and a track ball, the locking sleeve is rotatably sleeved on the locking fixing shaft, fixedly installed at one end of the roller tube, and the locking fixing shaft is fixedly installed on the first mounting bracket or the second mounting bracket set at the end of the roller tube;
the outer surface of the locking fixing shaft is provided with a track groove, and the corresponding position of the inner wall of the locking sleeve has a groove hole, the track ball is located inside the groove hole, when the locking sleeve rotates relative to the locking fixing shaft, the track ball moves along the track groove under the drive of the locking sleeve, at a certain position in the track groove, the track ball is unidirectionally locked.

7. According to claim 6, the gap-adjustable, quick non-penetrating installation roller blind, wherein:
the no-pull spring system comprises a fixed rod, springs, a head, a damper, and a unidirectionally roller;
both the head and the unidirectionally roller are both installed on the roller tube and rotate synchronously, one end of the fixed rod extends through the head and is fixedly mounted to the first or second mounting bracket, while the other end is fixedly mounted with the damper, the damper is assembled with the one-way roller, and a spring is mounted on the fixed rod, with its ends fixed respectively to the head and the housing of the damper;
when the roller tube rotates downward along the roller blind body, the head rotates together with the roller tube, causing the torsional force of the spring to increase, during this process, the damper moves under the action of the unidirectionally roller to provide damping, when the roller tube rotates upward along the roller blind body, the torsional force of the spring is released, causing the roller tube to rotate back, during this process, the unidirectionally roller rotates freely with the roller tube, and the damper remains stationary.

8. According to claim 7, the gap-adjustable, quick non-penetrating installation roller blind, wherein:
the unidirectionally roller comprises a pulley body, a rotating shaft, and a rotating disk;
the pulley body is installed inside the roller tube and moves synchronously with it, the rotating disk is mounted inside the pulley body and rotatably sleeved on the shaft, the bottom of the pulley body is equipped with an inclined plane, which is used to match with the rotating disk;
one end of the rotating shaft is connected to the damper, and the rotating shaft is equipped with a gear disk, which is uniformly distributed with inclined teeth, these sawteeth can mesh with the inclined sawteeth on the rotating disk in same direction and disengage in the opposite direction, thereby achieving unidirectional rotation;
when the pulley body rotates downward along the roller blind body, the rotating disk and the rotating shaft fit together under the action of the inclined plane, and their sloping sawteeth mesh, thus achieving synchronized rotation; when the pulley body rotates in the opposite direction, the rotating disk disengages from the rotating shaft, and the rotating shaft remains stationary.

9. According to claim 1, the gap-adjustable, quick non-penetrating installation roller blind, wherein:
the non-penetrating installation mechanism comprises a pre-tensioning component, a supporting component, a pressure component, and a button component;
the supporting components comprise a first supporting portion and a second supporting portion capable of relative sliding, the first supporting portion is supported on the supporting wall, while the second supporting portion is connected to the supporting rail, the pressure components consist of a first pressure portion and a second pressure portion, the first pressure portion is installed in conjunction with the first supporting portion, and the second pressure portion is installed in conjunction with the second supporting portion;
the pre-tensioning component is installed between the first pressure portion and the second supporting portion, while the button component is installed on the second supporting portion and connected to the second pressure portion, when the button component is closed, the second pressure portion applies tightening force towards the supporting wall to the first pressure portion and the first supporting portion installed in conjunction with it.

10. According to claim 9, the gap-adjustable, quick non-penetrating installation roller blind, wherein:
the first supporting portion includes a supporting seat, and the second supporting portion includes a base, with the supporting seat and the base slidingly connected;
the first pressure portion comprises an sloping top block, which is installed within the supporting base, the sloping top block has second trapezoidal protrusion on its sides, while corresponding first trapezoidal protrusion are provided inside the supporting base, the second trapezoidal protrusion make contact with the first trapezoidal protrusion via inclined surface, the pre-tensioning component is a spring, with its ends fixed respectively to the sloping top block and the base, the pre-tension force provided by the spring causes the sloping top block to press the supporting base towards the supporting wall;
the second pressure portion comprises a square top block, which is positioned within a square hole in the base and can slide relative to the opening both inward and outward, the inner side of the square top block is equipped with the square top block sawteeth, while the outer side of the sloping top block is equipped with the sloping top block sawteeth;
the button component is installed on the base and connected to the square top block, when the button component is closed, it pushes the square top block inward, as a result, the square top block drives the sloping top block inward, and the square top block sawteeth engage with the sloping top block sawteeth, this arrangement prevents relative sliding between the sloping top block and the square top block, thereby generating an inclined surface force between them.

11. According to claim 1, the gap-adjustable, quick non-penetrating installation roller blind, wherein the lower end of the supporting rail extends towards the roller blind mechanism to form a light-blocking plate, additionally/alternatively, the end cap assembly and the roller blind installation mechanism are provided with anti-slip components at one end supported by the supporting wall.

12. According to claim 2, the gap-adjustable, quick non-penetrating installation roller blind, wherein the roller blind body comprises a fabric and a lower rail assembly, with a groove provided at the lower end of the roller tube, the upper end of the fabric is clamped in the groove of the roller tube, and the lower rail assembly is positioned at the bottom of the fabric to provide vertical weight.
